(19) United States
(12) Patent Application Publication
(10) Pub. No.: US 2025/0128248 A1
(43) Pub. Date: Apr. 24, 2025

(54) CATALYTIC FIBERS AND APPLICATIONS THEREOF

(71) Applicants: CORMETECH, INC., Durham, NC (US); Evonik Fibres GmbH, Schoerfling (AT)

(72) Inventors: Christopher J. Bertole, Durham, NC (US); Scot Pritchard, Durham, NC (US); Samuel Richardson, Roxboro, NC (US); Max Morris, Durham, NC (US); Stefano Santorsola, Schoerfling (AT); Florin Popovici, Schoerfling (AT)

(21) Appl. No.: 18/835,597

(22) PCT Filed: Feb. 6, 2023
(86) PCT No.: PCT/US2023/012398

§ 371 Date: Aug. 2, 2024

Related U.S. Application Data
(60) Provisional application No. 63/306,678, filed on Feb. 4, 2022.

(51) Int. Cl. B01J 35/58; B01J 23/30

(52) U.S. Cl. CPC B01J 35/58; B01J 23/30

(57) ABSTRACT

Catalytic fibers are described herein and, in particular, catalytic fibers exhibiting properties and architecture operable to provide catalytic fabrics exhibiting low pressure drop. In some embodiments, a catalytic fiber comprises a fiber body including one or more channels along surfaces of the fiber body, and catalytic material residing within the one or more channels.

### RELATED APPLICATION DATA

The present application claims priority pursuant to Article 8 of the Patent Cooperation Treaty to U.S. Provisional Patent Application Ser. No. 63/306,678 filed Feb. 4, 2022 which is incorporated herein by reference in its entirety.

### FIELD

The present invention relates to catalytically active fiber constructions and, in particular, to catalytically active fibers and fabrics operable for the selective catalytic reduction of nitrogen oxides.

### BACKGROUND

Denitrification or selective catalytic reduction (SCR) technology is commonly applied to combustion-derived flue gases for removal of nitrogen oxides when passed through a catalytic reactor. Denitrification comprises the reaction of nitrogen oxide species in the gases, such as nitrogen oxide (NO) or nitrogen dioxide (NO₂), with a nitrogen containing reductant, such as ammonia or urea, resulting in the production of diatomic nitrogen (N₂) and water. Moreover, various absorbent or capture technologies are used to remove other chemical species of a flue gas that are not catalytically decomposed.

In many cases, exhaust gas streams flowing through modularized sections of a catalytic reactor and other downstream apparatus, such as bag houses, experience pressure drop. Pressure drop can result from structures, frictional forces and other factors impeding or resisting the flow of the exhaust gas stream. Pressure drop can result in various inefficiencies and cause parasitic power losses during industrial applications such as electrical power generation.

### SUMMARY

In view of these disadvantages, catalytic fibers are described herein and, in particular, catalytic fibers exhibiting properties and architecture operable to provide catalytic fabrics exhibiting low pressure drop. In some embodiments, a catalytic fiber comprises a fiber body including one or more channels along surfaces of the fiber body, and catalytic material residing within the one or more channels. The one or more channels, in some embodiments, extend along a longitudinal axis of the fiber body. When extending along a longitudinal axis, the channels can define lobes between the channels, the lobes extending radially outward from the fiber center. Alternatively, one or more channels can extend along a circumference of the fiber body. When extending around the fiber circumference, the channels can define sections of the fiber. In some embodiments, the channels extend helically along the longitudinal axis of the fiber body.

The channels in the fiber body can have any desired cross-sectional profile. In some embodiments, the channels have a curved cross-sectional profile. In other embodiments, the channels have a polygonal or curvelinear cross-sectional profile. Channels of a fiber may all have the same cross-sectional profile or the profiles may differ depending on radial and/or longitudinal positioning of the channel on the fiber body.

In another aspect, catalytically active fabrics are provided. Catalytically active fabrics comprise the catalytic fibers described above, the fibers including one or more channels along surfaces of the fiber body, and catalytic material residing within the one or more channels. In some embodiments, the fabric is a non-woven assembly of the catalytic fibers. Non-woven fabrics can be formed by several techniques, including needle punching or using a binder. In other embodiments, the fabric can be a woven assembly of the catalytic fibers.

These and other embodiments are further described in the following detailed description.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Catalytic Fibers

In one aspect, a catalytic fiber comprises a fiber body including one or more channels along surfaces of the fiber body, and catalytic material residing within the one or more channels. The one or more channels, in some embodiments, extend along a longitudinal axis of the fiber body. When extending along a longitudinal axis, the channels can define lobes between the channels, the lobes extending radially outward from the fiber center. Catalytic fibers described herein can comprise any desired number of channels and lobes. In some embodiments, the channels and associated lobes are rotationally symmetric. For example, the channels can exhibit the same or substantially the same radial spacing, such as 120 degrees from one another. In such embodiments, the lobes exhibit the same or substantially the same radial spacing of 120 degrees. Radial spacing of the channels and lobes can be dependent on several considerations, including the number of channels, channel geometry, and lobe geometry. In other embodiments, radial spacing of the lobes and/or channels is irregular or non-symmetrical.

The fiber body can be formed of any material not inconsistent with the technical objectives described herein, including use in SCR applications. In some embodiments, the fiber body is formed of glass. In other embodiments, the fiber body is formed of a polymeric material, including homopolymers and copolymers. The polymeric material, in some embodiments, can exhibit thermal stability at temperatures ranging from 120° C. to 350° C. The polymeric material, for example, can be polyimide. In some embodiments, the polymeric material is polyetherketone (PEK) or polyetheretherketone (PEEK). The polymeric material may also be selected from the group consisting of polyester, polyamide, polyphenylene-sulfide, polyacrylic, polypropylene, polycarbonate and polyfluoroethylene fiber.

The fiber body, in some embodiments, is formed of a single polymeric or copolymeric material. Alternatively, the fiber body can be formed of two or more polymeric/copolymeric materials. In some embodiments, for example, the fiber body exhibits a core/shell architecture. The core can be formed of a polymeric or copolymeric material providing desirable mechanical properties, and the shell being formed of a polymeric or copolymeric material exhibiting compatible interactions with the particulate catalytic material residing in the fiber channels. In further embodiments, the fiber body can be hollow, such as a hollow polyimide fiber. The fiber body can have any diameter consistent with the technical objectives described herein, including formation of catalytic fabrics with low pressure drop. In some embodiments, the fiber body has a maximum diameter of 10 μm to 2 mm. Maximum diameter of a fiber body, in some embodiments, is measured from lobe to lobe. Diameter of the fiber body, in some embodiments, is 100 μm to 1 mm or 250 μm to 1 mm. In some embodiments, maximum diameter of a fiber body is greater than 2 mm.

As described herein, catalytic material resides within the channels. In some embodiments, at least 5 percent of channel volume or at least 10 percent of channel volume is filled with catalytic material. Channel volume filled with catalytic material may also have a value selected form Table I.

TABLE I
Channel Volume Filled with Catalytic Material (%)
10-70
20-60
25-55
15-50
10-40
70-95

Channels in the fiber body can have any desired cross-sectional shape. In some embodiments, the channels have a curved cross-sectional shape, as such as semi-circular, elliptical, or parabolic. Alternatively, channel cross-sectional shape can be polygonal, such as square, rectangular or hexagonal. In further embodiments, channel cross-sectional shape can be curve-linear.

Any catalytic material consistent with the technical objectives described herein can be positioned in fiber channels. In some embodiments, the catalyst is operable for the selective catalytic reduction of nitrogen oxides, destruction of dioxin, furan and/or volatile organic compounds (VOCs), as well as carbon monoxide (CO) oxidation. The catalytic material, for example, can comprise one or more platinum group metals (PGM), including gold, platinum, iridium, palladium osmium, rhodium, rhenium, ruthenium, vanadium pentoxide (V₂O₅), tungsten oxide (WO₃), molybdenum oxide (MoO₃) or other noble metals or mixtures/alloys thereof. In some embodiments, the catalytic material is a vanadium-tungsten-titanium alloy (V—W—Ti). The catalytic material can exhibit particle morphology. In some embodiments, particles of any of the foregoing catalytic metals, alloys or metal oxides are employed. Additionally, in some embodiments, the particles comprise an inorganic oxide carrier and catalytically active metal functional group. The inorganic oxide carrier can include, but is not limited to, titania (TiO₂), alumina (Al₂O₃), zirconia (ZrO₂), and/or mixtures thereof. Moreover, in some embodiments, the catalytically active metal functional group includes, but is not limited to, gold, platinum, iridium, palladium osmium, rhodium, rhenium, ruthenium, vanadium pentoxide (V₂O₅), tungsten oxide (WO₃), molybdenum oxide (MoO₃) or other noble metals or mixtures thereof. In some embodiments, the catalytic material comprises one or more zeolites incorporating one or more catalytic metals or alloys, such as zeolite supported PGM. For example, the catalytic material can comprise copper-zeolite including Cu-SSZ-13.

As described above, the catalytic material can be particulate in nature. In being particulate, the catalytic material, in some embodiments, does not form any chemical interactions with the fiber and is held within the fiber channels and any interstitial spaces of the fabric discussed below by mechanical engagement.

### II. Catalytically Active Fabrics

In another aspect, catalytically active fabrics are described herein. Catalytically active fabrics comprise the catalytic fibers described in Section I above. In some embodiments, the fabric is a non-woven assembly of the catalytic fibers. Non-woven fabrics can be formed by several techniques, including needle punching or using a binder. In other embodiments, the fabric can be a woven assembly of the catalytic fibers.

Advantageously, the catalytically active fabrics exhibit desirable porosity while maintaining effective catalytic activity. Desirable porosity can assist in maintaining lower pressure drop across or through the fabric. In some embodiments, the catalytic fabric exhibits porosity of at least 40 vol. %. Porosity of the catalytic fabric, in some embodiments, has a value selected from Table II.

TABLE II
Porosity of Catalytic Fabric (vol. %)
≥50
≥60
40-85
40-80
50-75
55-85

Porosity of the catalytic fabric can be dependent on several considerations, including woven or non-woven construction of the fabric, catalytic loading of the fabric, layering of the fabric, and/or initial porosity of the fabric in the non-catalytic state. As described further herein, the catalytic fabrics can be produced directly from the catalytic fibers described in Section I, or catalytic material can be applied to a non-catalytic fabric, thereby imparting the catalytic material in the channels of the fibers.

Catalytic fabrics can have any desired catalytic loading. In some embodiments, catalytic material is present in the fabric in an amount of 40 weight percent to 80 weight percent of the catalytic fabric. Catalytic material may also be present in an amount of 50 weight percent to 75 weight percent of the catalytic fabric. As described herein, catalytic material resides in the channels of the fiber bodies. Additionally, in some embodiments, catalytic material also resides in interstitial spaces between the fibers. Advantageously, the catalytic fabric can exhibit a porosity described herein, including a porosity selected from Table II, wherein catalytic material resides in fiber channels and fabric interstitial spaces. In some embodiments, catalytic fabrics having composition and properties described herein can remove greater than 50 percent or greater than 60 percent of NOₓ from a gas stream passed through the fabrics. Moreover, the catalytic material of the fabric can be stable to various cleaning processes, such as back-flushing or other methods of removing particulate contaminants from the fabric. For example, the catalytic fabric can maintain a de-NOₓ efficiency of greater than 50 percent after at least five or ten cleaning cycles.

Fabrics described herein can be employed in a variety of applications, including bag house applications associated with power generation stations and other industrial filtration/gas treatment operations.

These and other embodiments are further illustrated in the following non-limiting examples.

### Example 1—Catalytic Fabric

High temperature (HT) polyimide fibers having a multichannel/multi-lobe cross-section commercially available from Evonik Fibres GmbH of Schorfling, Austria under the P84® trade designation were fashioned into a non-woven filter bag architecture. An aqueous slurry of V—W/Ti catalytic material was made. The non-woven filter bag was contacted with the slurry and mechanically pressed to impart the V—W/Ti catalytic material to the polyimide fibers. Mechanical pressing of the coated fibers deposited the V—W/Ti catalytic material into channels of the polyimide fibers as well as into interstitial spaces of the non-woven fabric. Application of the slurry followed by mechanical pressing was administered until a loading of 40-45 wt. % of catalytic material was achieved. The catalytic non-woven filter bag was subsequently dried and de-dusted.

### Example 2—Selective Catalytic Reduction with Catalytic Fabric

The catalytic non-woven filter bag of Example 1 was subjected to de-NOₓ testing as set forth in Table III.

TABLE III
Catalytic Fabric de-NOₓ testing

| Test | Flow | Flow | | | NH3 |
|---|---|---|---|---|---|
| # | [Nm3/m2 · min] | [m3/m2 · min] | T [C.] | DeNOx | Slip |
| 1 | 0.25 | 0.43 | 200 | 62.1% | 9.6 |
| 2 | 0.25 | 0.41 | 176 | 55.4% | 19.6 |
| 3 | 1.00 | 1.74 | 201 | 33.0% | 9.9 |
| 4 | 1.00 | 1.65 | 177 | 22.2% | 10.1 |

Test gas composition: 170 ppmv NOx, 8% O2 15% H2O.

As provided in Table III, the catalytic non-woven filter bag exhibited significant nitrogen oxide reduction in the gas stream at various conditions.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A catalytic fiber comprising:
a fiber body including one or more channels along surfaces of the fiber body; and
catalytic material residing within the one or more channels.

2. The catalytic fiber of claim 1, wherein the one or more channels extend along a longitudinal axis of the fiber body.

3. The catalytic fiber of claim 2 comprising a plurality of channels defining lobes between the channels.

4. The catalytic fiber of claim 1, wherein the one more channels extend along a circumference of the fiber body.

5. The catalytic fiber of claim 1, wherein the one or more channels have a curved cross-sectional profile.

6. The catalytic fiber of claim 1, wherein the one or more channels have a polygonal cross-sectional profile.

7. The catalytic fiber of claim 1, wherein the one or more channels have a curvelinear cross-sectional profile.

8. The catalytic fiber of claim 1, wherein the catalytic material fills at least 5 percent of channel volume.

9. The catalytic fiber of claim 1, wherein the catalytic material fills at least 50 percent of channel volume.

10. The catalytic fiber of claim 1, wherein the one or more channels extend helically along a longitudinal axis of the fiber body.

11. The catalytic fiber of claim 1, wherein the catalytic material is operable for the selective catalytic reduction of nitrogen oxides.

12. The catalytic fiber of claim 1, wherein the catalytic material comprises one or more of gold, platinum, iridium, palladium osmium, rhodium, rhenium, ruthenium, vanadium pentoxide (V₂O₅), tungsten oxide (WO₃), or molybdenum oxide (MoO₃).

13. The catalytic fiber of claim 1, wherein the fiber body is formed of glass.

14. The catalytic fiber of claim 1, wherein the fiber body is formed of a polymeric material.

15. The catalytic fiber of claim 14, wherein the polymeric material exhibits thermal stability at temperatures exceeding 200° C. or 250° C.

16. The catalytic fiber of claim 14, wherein the polymeric material exhibits thermal stability at temperatures from 120° C. to 350° C.

17. The catalytic fiber of claim 14, wherein the polymeric material is polyimide.

18. The catalytic fiber of claim 14, wherein the polymeric material is polyetherketone (PEK) or polyetheretherketone (PEEK).

19. The catalytic fiber of claim 1, wherein the catalytic material is particulate.

20. A catalytically active fabric comprising:
catalytic fibers including a fiber body comprising one or more channels along surfaces of the fiber body, and catalytic material residing within the one or more channels.

21. The catalytically active fabric of claim 20, wherein the catalytic fibers are non-woven.

22. The catalytically active fabric of claim 20, wherein the catalytic fibers are woven.

23. The catalytically active fabric of claim 20, wherein the catalytic material also resides in interstitial spaces defined by the catalytic fibers of the fabric.

24. The catalytically active fabric of claim 23, wherein the catalytic material is present in an amount of 40 weight percent to 80 weight percent of the fabric.

25. The catalytically active fabric of claim 24 having a porosity of 40-80 vol. %.

26. The catalytically active fabric of claim 20, wherein the fabric has a bag architecture.

27. The catalytically active fabric of claim 26 having a de-NOₓ efficiency of at least 50 percent.
